(19) United States
(12) Patent Application Publication
(10) Pub. No.: US 2016/0052642 A1
(43) Pub. Date: Feb. 25, 2016

(54) AIRCRAFT ELECTRIC TAXI HEALTH MANAGEMENT SYSTEM AND METHOD

(71) Applicant: HONEYWELL INTERNATIONAL INC., MORRISTOWN, NJ (US)

(72) Inventors: Grant Gordon, Peoria, AZ (US); Steve Abel, Chandler, AZ (US); Kyusung Kim, Plymouth, MN (US)

(73) Assignee: HONEYWELL INTERNATIONAL INC., MORRISTOWN, NJ (US)

(21) Appl. No.: 14/467,423

(22) Filed: Aug. 25, 2014

(51) Int. Cl. B64D 45/00; B64C 25/34; B64C 25/40; G07C 5/08

(52) U.S. Cl. CPC B64D 45/00; G07C 5/0808; B64C 25/34; B64C 25/405; G07C 5/0816; B64D 2045/0085

(57) ABSTRACT

An aircraft electric taxi health management system includes a right electric motor drivingly connected to at least one wheel on a right landing gear assembly, a left electric motor drivingly connected to at least one wheel on a left landing gear assembly, a right motor controller configured to electrically drive the right electric motor, monitor the right motor current and voltage, and generate right motor signals as a function of the right motor current and voltage; a left motor controller configured to electrically drive the left electric motor, monitor the left motor current and voltage, and generate left motor signals as a function of the left motor current and voltage; and a health management controller configured to compare the right motor signals to the left motor signals; and generate electric taxi system maintenance signals based on the comparison.

### BACKGROUND OF THE INVENTION

The present invention generally relates to health management systems and methods for aircrafts with electric drive taxi systems.

Some aircrafts now include electric drive taxi systems to replace or augment the main aircraft engines while the aircraft is on the ground taxiing. Many of these electric drive systems may use controllers which control and monitor current and voltage supplied to electric motors, which rotate the wheels on landing gear to move the aircraft, and may monitor other operating parameters as well. The monitored parameters may present an opportunity for performing real-time and ongoing diagnostic and prognostic operations onboard the aircraft. These operations may diagnose immediate maintenance and operational problems and/or identify when components of the electric drive taxi-system may need service.

While past systems may monitor landing gear component health, the components may not include components of an electric drive taxi system.

As can be seen, there may be an ongoing need for diagnostic and prognostic maintenance monitoring of electric drive taxi systems.

### SUMMARY OF THE INVENTION

In one aspect of the present invention, an aircraft electric taxi health management system, comprises a pilot interface unit configured to accept taxi drive commands, and generate a first torque command and a second torque command as a function of the taxi drive commands; a first electric motor drivingly connected to at least one wheel on a first landing gear assembly, and including a first motor current and a first motor voltage; a second electric motor drivingly connected to at least one wheel on a second landing gear assembly, and including a second motor current and a second motor voltage; a first motor controller configured to electrically drive the first electric motor as a function of the first torque command, monitor the first motor current and the first motor voltage of the first electric motor, and generate a first motor torque signal as a function of the first motor current and the first motor voltage; a second motor controller configured to electrically drive the second electric motor as a function of the second torque command, monitor the second motor current and the second motor voltage of the second electric motor, and generate a second motor torque signal as a function of the second motor current and the second motor voltage; and a health management controller configured to compare first torque command and the first motor torque signal, and the second torque command and the second motor torque signal, and generate electric taxi system maintenance signals based on the comparison.

In another aspect of the present invention, an aircraft electric taxi health management method, comprises accepting taxi drive commands through a pilot interface unit; generating a first torque command and a second torque command as a function of the taxi drive commands; driving a first electric motor with a first motor controller based on the first torque command; driving a second electric motor with a second motor controller based on the second torque command; monitoring a first motor current and a first electric motor voltage of the first electric motor, and generating first motor signals as a function of the first motor current and the first motor voltage; monitoring a second motor current and a second electric motor voltage of the second electric motor, and generating second motor signals as a function of the second motor current and the second motor voltage; and comparing the first motor signals to the second motor signals; and generating electric taxi system maintenance signals based on the comparison.

In yet another aspect of the present invention, an aircraft with an electric taxi system, comprises a pilot interface unit configured to accept taxi drive commands, and generate a first torque command and a second torque command as a function of the taxi drive commands; a first landing gear assembly including a first electric motor drivingly connected to at least one wheel, the first electric motor including a first motor current and a first motor voltage; a second landing gear assembly including a second electric motor drivingly connected to at least one wheel, the second electric motor including a second motor current and a second motor voltage; an auxiliary power unit selectively electrically connected to a first electric motor controller and the a second electric motor controller; the first motor controller configured to electrically drive the first electric motor as a function of the first torque command, monitor a first motor current and a first motor voltage of the first electric motor, and generate first motor signals as a function of the first motor current and the first motor voltage; the second motor controller configured to electrically drive the second electric motor as a function of the second torque command, monitor a second motor current and a second motor voltage of the second electric motor, and generate second motor signals as a function of the second motor current and the second motor voltage; and a health management controller configured to compare the first motor signals to the second motor signals; and generate electric taxi system maintenance signals based on the comparison.

These and other features, aspects and advantages of the present invention will become better understood with reference to the following drawings, description and claims.

### BRIEF DESCRIPTION OF THE DRAWINGS

FIG. 1 is a block diagram of an aircraft with an electric taxi health management system according to an exemplary embodiment of the present invention;

FIG. 2 is a schematic and flow chart of an aircraft electric taxi health management method according to an exemplary embodiment of the present invention;

FIG. 3 is a flow chart of an initial health check method for an aircraft electric taxi system according to an exemplary embodiment of the present invention;

FIG. 4A is a flow chart of a first portion of a method to check tire inflation for an aircraft electric taxi system according to an exemplary embodiment of the present invention;

FIG. 4B is a flow chart of a second portion of the method to check tire inflation for an aircraft electric taxi system of FIG. 4A;

FIG. 5A is a flow chart of a first portion of a method to check side loading for an aircraft electric taxi system according to an exemplary embodiment of the present invention;

FIG. 5B is a flow chart of a second portion of the method to check side loading for an aircraft electric taxi system of FIG. 5A;

FIG. 6 is a flow chart of a traction control method and a skid control method for an aircraft electric taxi system according to an exemplary embodiment of the present invention;

FIG. 7 is a flow chart of a method to monitor brake wear for an aircraft electric taxi system according to an exemplary embodiment of the present invention;

FIG. 8A is a flow chart a first portion of a method to monitor the weight and balance of an aircraft with an electric taxi system according to an exemplary embodiment of the present invention;

FIG. 8B is a flow chart a second portion of the method to monitor the weight and balance of an aircraft with an electric taxi system of FIG. 8A;

FIG. 9A is a flow chart of a health management method for electric motors in an aircraft electric taxi system according to an exemplary embodiment of the present invention; and

FIG. 9B is a flow chart of a method of generating condition indicators of electric motors in an aircraft electric taxi system according to an exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention generally provides a health management system and method for an aircraft with an electric drive taxi system. In general, aircraft with electric drive systems may use controllers which control and monitor current and voltage supplied to electric motors, which rotate the wheels on landing gear to move the aircraft, and may monitor other operating parameters as well. The monitored parameters may present an opportunity for performing real-time and ongoing diagnostic and prognostic operations onboard the aircraft. These operations may diagnose immediate maintenance and operational problems and/or identify when components of the electric drive taxi-system may need service.

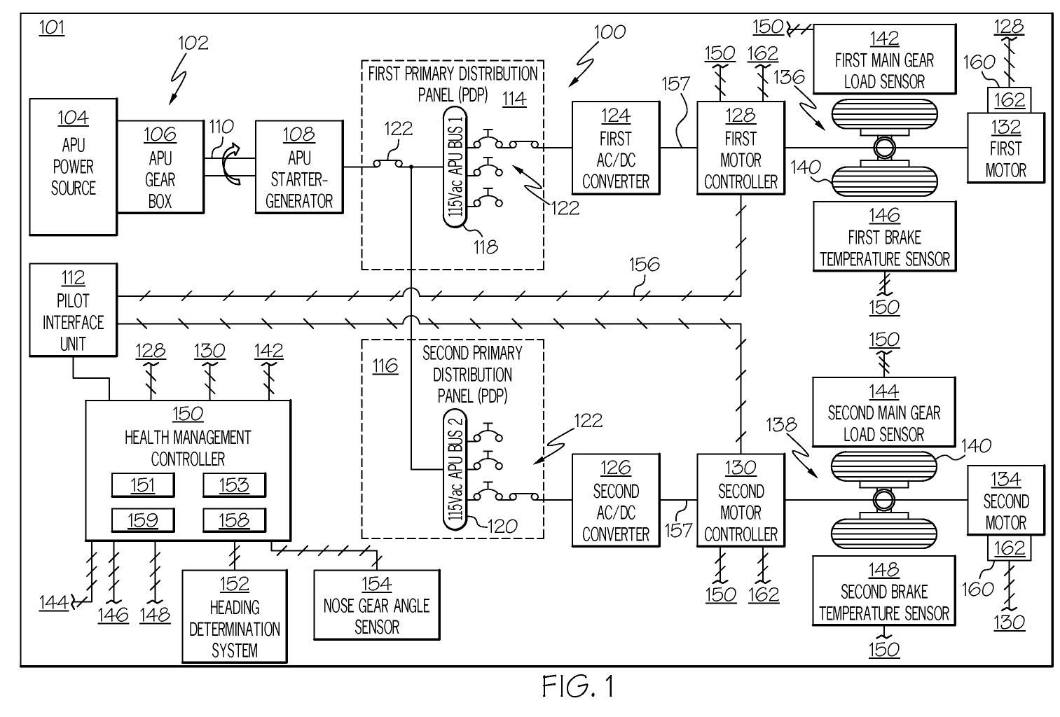

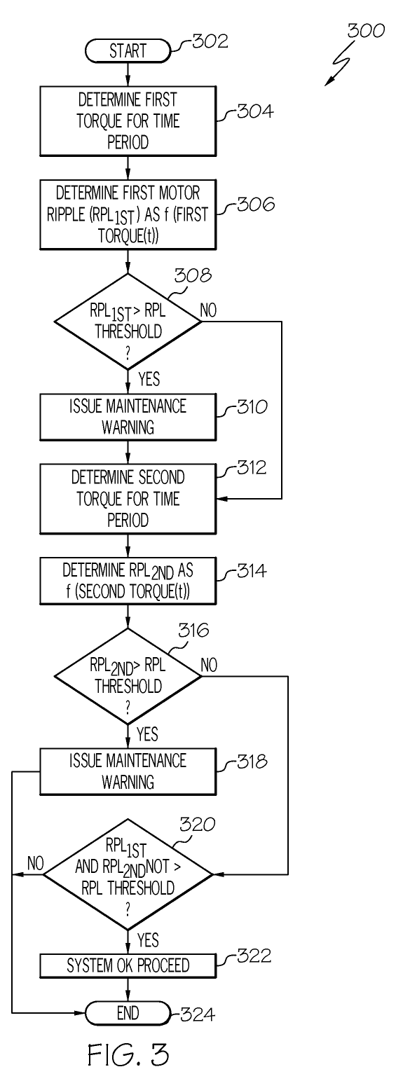

Referring now to FIG. 1, an exemplary embodiment of a health management (HM) system 100 for an aircraft 101 having an electric taxi system is illustrated. The system 100 may include a pilot interface unit 112 configured to accept taxi drive commands, and generate a first torque command and a second torque command as a function of the taxi drive commands; a first motor 132 drivingly connected to at least one wheel 140 on a first landing gear assembly 136, and including a first motor current and a first motor voltage; a second motor 134 drivingly connected to at least one wheel 140 on a second landing gear assembly 138, and including a second motor current and a second motor voltage; a first motor controller 128 configured to electrically drive the first motor 132 as a function of the first torque command, monitor the first motor current and the first motor voltage of the first motor 132, and generate first motor signals as a function of the first motor current and the first motor voltage; and a second motor controller 130 configured to electrically drive the second motor 134 as a function of the second torque command, monitor the second motor current and the second motor voltage of the second motor 134, and generate second motor signals as a function of the second motor current and the second motor voltage; and a health management (HM) controller 150 configured to compare the first motor signals, and the second motor signals; and generate electric taxi system maintenance signals based on the comparison. In one exemplary embodiment, the first landing gear assembly 136 and first motor 132 may be located on the right side of an aircraft 101, and the second landing gear assembly 138 and second motor 134 may be located on the left side of the aircraft 101 in relation to a pilot on a flight deck of the aircraft positioned to pilot the aircraft. Maintenance signals may include, but are not limited to, maintenance flags, maintenance warnings, flight deck warnings, diagnostic messages, prognostic service information, and other maintenance signals described later in this description in relation to FIGS. 3, 4A, 4B, 5A, 5B, 6-7, 8A, 8B, 9A, and 9B.

The first motor 132 and the second motor 134 may include any electric motor suitable for an aircraft 101 electric drive taxi system as is known in the art. The motors 132, 134 may be, for example, AC permanent magnet motors.

The aircraft 101 may include an auxiliary power unit (APU) assembly 102 which may include an APU power source 104 drivingly connected to an APU starter-generator 108 through an APU gear-box 106, and a mechanical connection 110. The APU starter-generator 108 may be selectively electrically connected to and may selectively provide electric power to the first motor controller 128, and the second motor controller 130 to move the aircraft 101 along the ground during taxi and landing operations. The APU 102 may also power other systems on the aircraft during flight and ground operations as would be known in the art.

Power from the APU starter generator 108 may flow through a first primary distribution panel (PDP) 114 and a second primary distribution panel (PDP) 116 to a first AC/DC converter 124 and a second AC/DC converter 126 respectively. Both the first PDP 114 and the second PDP 116 may include an AC power bus 118, 120. The AC power buses 118, 120 may be about 115 Vac and may be selectively electrically connected to the APU starter generator 108 and the AC/DC converters 124, 126 through switches 122 and other electrical connectors 157. In general, electrical power connections in the schematic of FIG. 1 are represented by solid lines 157 without hatch marks.

The first motor controller 128 and the second motor controller 130 may be electrically connected to and provide current to the first motor 132 and the second motor 134 respectively, in a manner that causes the first motor 132 and the second motor 134 to generate torque and operate at a speed matching the commands from the HM controller 150. For example, the first and second motor controller 128, 130 may include inverter assemblies (not shown) which provide current at a frequency and amplitude which will result in the desired torque and speed. The first and second motor controllers 128, 130 may be communicatively connected through communication links 156 to the pilot interface unit 112 to receive torque commands, and to the HM controller 150. In general, communication links 156 are represented by lines with hatch marks in FIG. 1.

The first and second motor controllers 128, 130 may be operably connected to the first and second motors 132, 134, to monitor the first motor current, the first motor voltage, the second motor current, and the second motor voltage respectively. The first and second motor controllers 128, 130 may include one or more processors and memory components (not shown) as is known in the art. The first motor controller 128 may generate first motor signals as a function of the first motor current and first motor voltage. The second motor controller 130 may generate second motor signals as a function of second motor current and second motor voltage respectively. The first and second motor controllers 128, 130 may be communicatively connected to motor sensors 160 which may include motor temperature sensors 162. The motor temperature sensors 162 may be configured to generate a motor temperature sensor signal indicative of the temperature of a component of, or an area of the first or second motor 132, 134.

The first landing gear assembly 136 may include a first main gear load sensor 142 and a first brake temperature sensor 146. The second landing gear assembly 138 may include a second main gear loading sensor 144, and a second brake temperature sensor 148. The first and second main gear load sensors 142, 144 may be configured to generate a first main gear load signal and a second main gear load signal respectively, the main gear load signals indicative of the weight load on the main gear of the landing assemblies 136, 138. Main gear load sensors 142, 144 are known in the art, and may, for example, include a strain gauge. The first and second main gear load sensors 142, 144, may be communicatively connected to the HM controller 150.

The first and second brake temperature sensors 146, 148 may be configured to generate first and second brake temperature signals indicative of the temperature of a component of the braking system of the first and second landing gear assemblies 136, 138 respectively. For, example, the first and second brake temperature signals may be indicative of the temperature of a brake caliper (not shown) on a brake pad assembly (not shown). The first and second brake temperature sensors 146, 148 may be any brake temperature sensors known in the art. The first and second brake temperature sensors 146, 148 may be communicatively connected to the HM controller 150.

The HM system 100 may include a heading determination system 152 configured to determine the heading of the aircraft 101. Aircraft heading determination systems 152 are known in the art, and may include, in non-limiting examples, a GPS system, an inertial navigation system (INS), attitude and heading reference system (AHRS), and/or a smart map system. The heading determination system 152 may be located onboard the aircraft 101, and/or located remotely as is known in the art. The heading determination system 152 may be communicatively connected to the HM controller 150.

The HM system 100 may include a nose gear angle sensor 154 configured to generate a nose gear angle signal indicative of the steering angle of a nose gear of the aircraft 101. Nose gear angle sensors 154 are known in the art. The nose gear angle signal may be indicative of the heading of the aircraft. The nose gear angle sensor 154 may be communicatively connected to the HM controller 150.

The pilot interface unit 112 may be configured to allow an operator (pilot) to enter a desired aircraft speed and desired heading commands. The pilot interface unit 112 may generate first torque, first speed, second torque, second speed, and tiller commands as a function of the desired speed and heading commands entered. The pilot interface unit 112 may be dedicated to an electric taxi drive system, or may be an interface that allows control of multiple systems. The pilot interface unit 112 may generate a tiller angle signal as a function of the heading commands entered. The pilot interface unit 112 may be communicatively connected to the HM controller 150.

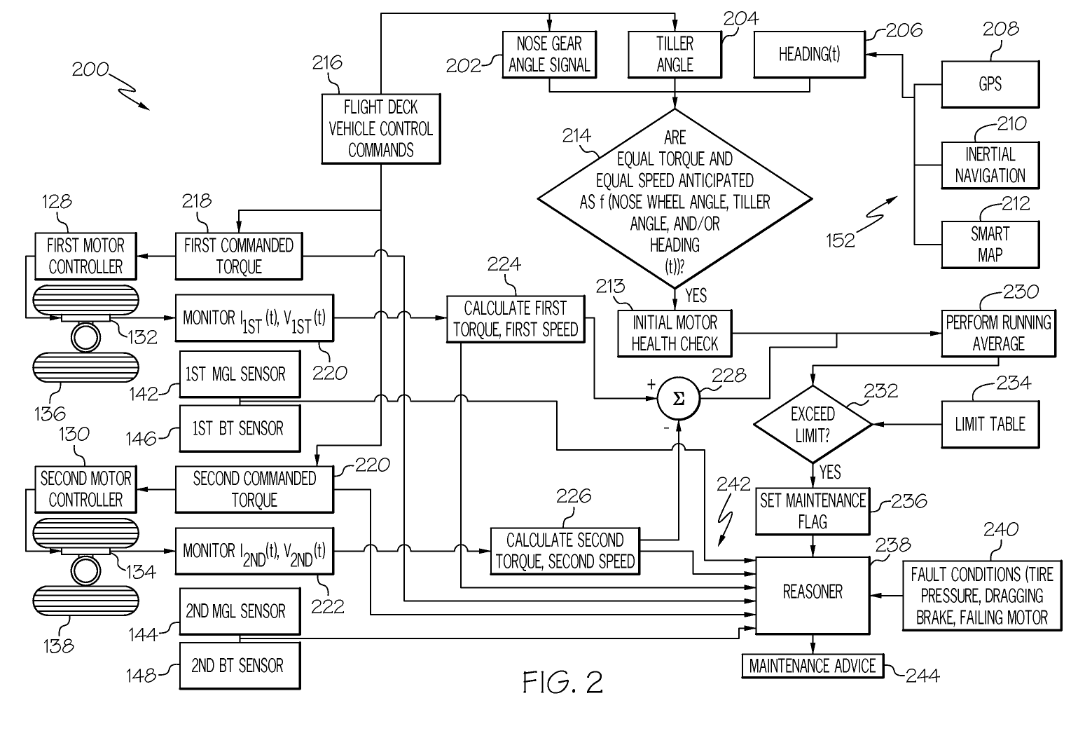

The HM controller 150 may include a processor 151 and a memory component 153. The processor 151 may include microprocessors or other processors as known in the art. In some embodiments the processor 151 may include multiple processors. The HM controller 150 may execute instructions, as described below and in relation to FIGS. 2-3, 4A, 4B, 5A, 5B, 6-7, 8A, 8B, 9A, and 9B, which may generate maintenance flags, advice, warnings and/or flight deck warnings; store maintenance data, and generate operational signals in response to first motor signals and second motor signals. In non-limiting examples, the HM controller 150 may execute instructions for checking tire inflation, checking aircraft 101 side loading, preventing aircraft skidding, improving aircraft traction, monitoring brake pad wear, checking for acceptable aircraft weight and balance, monitoring motor 132, 134 component health though condition indicators.

Such instructions may be read into or incorporated into a computer readable medium, such as the memory component 153, or provided external to processor 151. The instructions may include multiple lines or divisions of code. The lines or divisions of code may not be consecutive order, and may not be located in the same section of code. In alternative embodiments, hard-wired circuitry may be used in place of or in combination with software instructions as described above, below, or in relation to the drawings.

The term “computer-readable medium” as used herein refers to any non-transitory medium or combination of media that participates in providing instructions to the processor 151 for execution. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics.

Although shown as one physical unit, the HM controller 150 may include multiple units, or be part of a larger controller unit, as is known in the art.

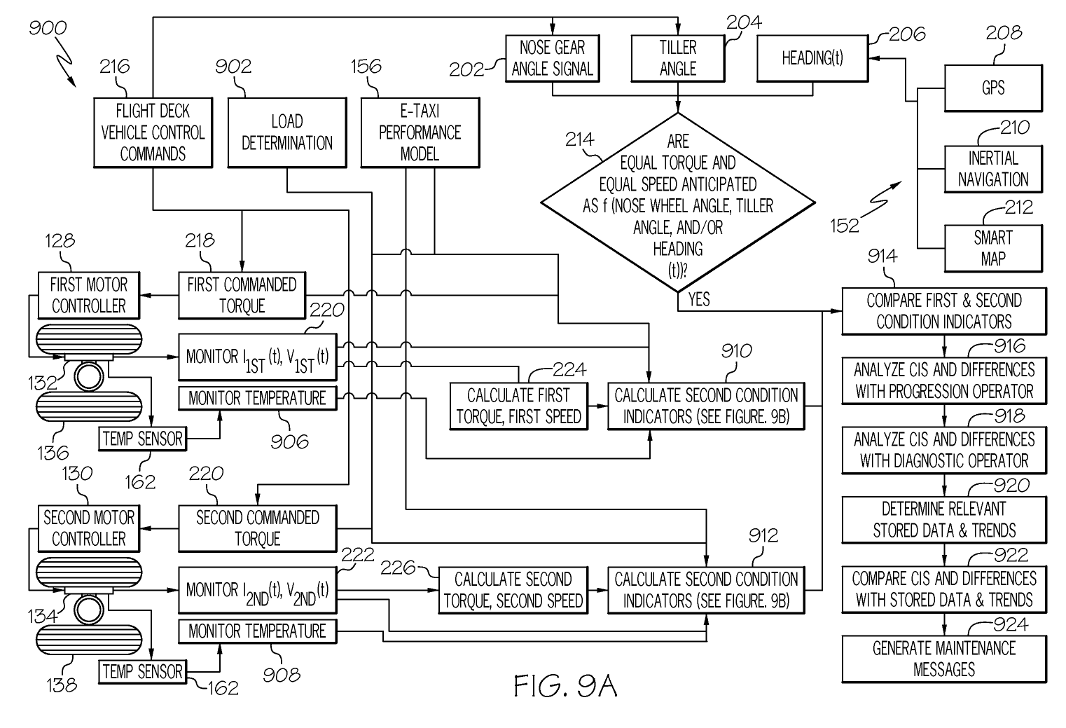

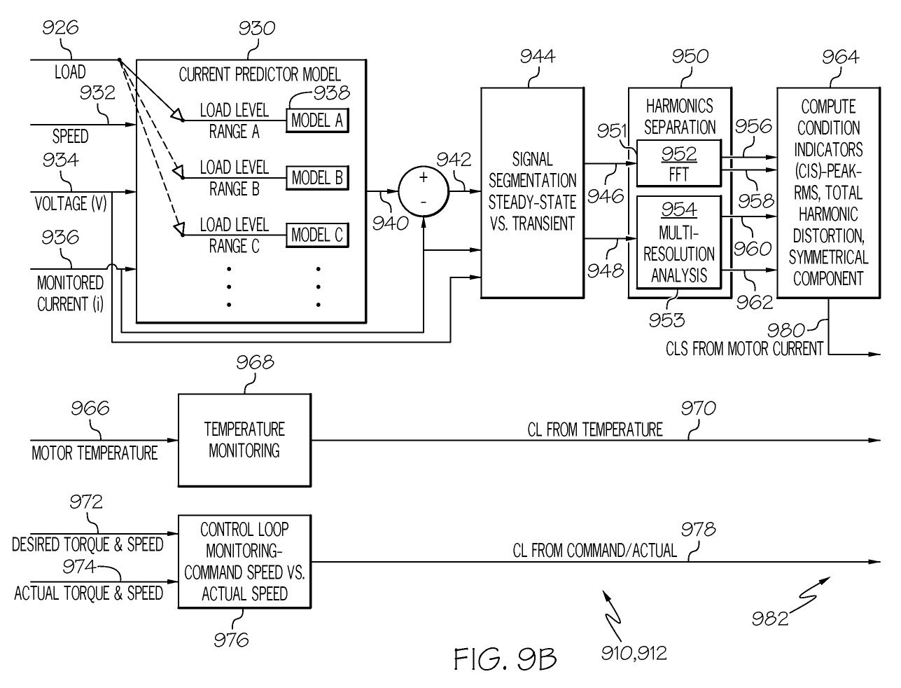

The HM controller 150 may include an e-taxi performance model 159 which may predict the performance of the electric drive taxi system and components of the electric drive taxi system as a function of operating parameters. The e-taxi performance model 159, may include multiple motor current prediction models (shown in relation to FIG. 9B) which may predict motor 132, 134 current based at least in part on motor speed, and motor voltage. Each motor current prediction model may be most accurate in a specific load range. The load ranges may vary among models.

The HM controller 150 may include a load determination model 158 which may estimate the load on the first motor 132 and the second motor 134 as a function of operating parameters and other variables. For example, operating parameters may include fuel consumption of the APU power source 104, aircraft 101 weight, and steering parameters; and other variables may include the number of passengers on the aircraft 101, and the weight and distribution of cargo. Load determination model 158 may include any model for estimating the load on the first motor 132 and the second motor 134 known in the art. Although illustrated separately from the processor 151 and the memory component 153, the e-taxi performance model 159, and the load determination model 158 may include parts of or the whole of the processor 151 and the memory component 153.

Referring now to FIG. 2, an exemplary embodiment of a HM method 200 for an aircraft 101 having an electric taxi system is illustrated. Components of the HM system 100 shown in FIG. 1 are identified with the same element number in FIG. 2. Blocks illustrating the HM method are designated with element numbers in the 200 series. The method may include accepting taxi drive commands through a pilot interface unit 112; generating a first torque command and a second torque command as a function of the taxi drive commands; driving a first motor 132 with a first motor controller 128 based on the first torque command; driving a second motor 134 with a second motor controller 130 based on the second torque command; monitoring a first motor current and a first motor voltage of the first motor 132, and generating first motor signals as a function of the first motor current and the first motor voltage; monitoring a second motor current and a second motor voltage of the second motor 134, and generating second motor signals as a function of the second motor current and the second motor voltage; and comparing the first motor signals, and the second motor signals; and generating electric taxi system maintenance signals based on the comparison.

The method 200 may begin at 214 by determining if equal torque and equal speed are expected from the first motor 132 and the second motor 134. In an embodiment where the first landing gear assembly 136 and the first motor 132 are located on the right side of the aircraft 101, and the second landing gear assembly 138 and the second motor 134 are located on the left side of the aircraft 101, generally, if the aircraft 101 is traveling in a straight path, it may be expected that the tires 140 on both sides will operate in similar conditions. If the tires 140 are operating in similar conditions, it may be expected that the first motor 132 and the second motor 134 will be required to generate equal torque and operate at equal speeds. The HM controller 150 may determine that the aircraft 101 is traveling in a straight path through the heading determination system 152, the nose gear angle signal, or the tiller angle as communicated from the pilot interface unit 112. If the HM controller 150 determines that equal torque and equal speed may be expected from the first motor 132 and the second motor 134, an initial health check may be performed at 213. The health check method may be any method of checking that the motors 132, 134 are functioning in a manner that the HM system 100 will function properly.

Referring now to FIG. 3, an exemplary initial health check method 300 is illustrated which may be a sub-method of the HM method 200 illustrated in relation to FIG. 2. The description of FIG. 2 will be returned to after describing the method 300 of FIG. 3. The method starts at 302. In step 304 the first motor 132 torque is determined for a time period. The first motor 132 torque may be determined by the HM controller 150 (or the first motor controller 128 and communicated to the HM controller 150) as a function of the first motor current and the first motor voltage which are monitored by the first motor controller 128. First motor ripple (RPL₁ₛₜ) may be determined as a function of the first motor torque by the HM controller 150, as is known in the art (step 306), and compared to a ripple threshold (RPL threshold) (step 308). The time period may be any time period equal to or greater than that needed to determine the RPL₁ₛₜ. The RPL threshold may be a predetermined value which is stored in the HM controller 150. If RPL₁ₛₜ is greater than the RPL threshold, the HM controller 150 may generate a maintenance warning (step 310). The maintenance warning may be include storing a flag in the memory of the HM controller 150, sending a signal to the flight deck or other location in the form of a display alarm or an audible alarm, or any other method known in the art of issuing a maintenance warning.

After the maintenance warning associated with the RPL₁ₛₜ being greater than the RPL threshold or if the RPL₁ₛₜ is not greater than the RPL threshold, the second motor 134 torque may be determined as a function of the second motor current and the second motor voltage for a time period (step 312). Second motor ripple (RPL_{2nd}) may be determined as a function of the second motor torque by the HM controller 150, as is known in the art (step 314), and compared to a ripple threshold (RPL threshold) (step 316). The time period may be any time period equal to or greater than that needed to determine the RPL_{2nd}. If RPL_{2nd} is greater than the RPL threshold, the HM controller 150 may generate a maintenance warning (step 318) and the method ends (step 324). If RPL_{2nd} is not greater than the RPL threshold, the HM controller 150 may check if both RPL₁ₛₜ and RPL_{2nd} are not greater than the RPL, (step 320) and if both RPL₁ₛₜ and RPL_{2nd} are not greater than the RPL, the HM controller 150 will determine that the motors 132, 134 are functioning in a manner that the HM system 100 will function properly (step 322). The method will then end (step 324).

Referring back to FIG. 2, if the HM controller 150 determines that the motors 132, 134 are functioning in a manner that the HM system 100 will function properly, the HM controller 150 may periodically compare the first motor torque and the second motor torque; and periodically compare the first motor speed and the second motor speed (block 228). The HM controller 150 may determine a running average of the difference between the first motor torque and the second motor torque, and determine a running average of the difference between the first motor speed and the second motor speed (block 230). The first motor torque and the first motor speed may be determined by the HM controller 150 as a function of the first motor current and the first motor voltage (block 224), which are monitored (block 220) by the first motor controller 128 or dedicated sensors. The second motor torque and the second motor speed may be determined by the HM controller 150 as a function of the second motor current and the second motor voltage (block 226), which are monitored (block 222) by the second motor controller 130 or dedicated sensors.

The HM controller 150 may determine if the running average of the difference between the first motor torque and the second motor torque exceeds a predetermined limit (block 232). The predetermined limit may be stored in a limit table (block 234). If the difference between the first motor torque and the second motor torque exceeds the predetermined limit, a maintenance flag may be set (block 236). The maintenance flag may be a stored flag in a memory section to be accessed by maintenance and service personnel, may be a warning which is displayed to the flight deck or other personnel, may be an audible alarm, or any other form of maintenance flag as would be known in the art.

The HM controller 150 may determine if the running average of the difference between the first motor speed and the second motor speed exceeds a predetermined limit (block 232). The predetermined limit may be stored in a limit table (block 234). If the difference between the first motor speed and the second motor speed exceeds the predetermined limit, a maintenance flag may be set (block 236) as described above.

The HM Controller 150 may include fault condition reasoner logic (block 240) to further analyze possible problems in the electric taxi system (block 238) as a function of condition indicators (242), when a maintenance flag is set, or in response to the condition indicators (242). Condition indicators (242) may be any operating parameter which may be used in pre-programmed logic to determine what fault conditions may be causing a difference between the first and second motor torque or speed to exceed the predetermined limit. For example, the condition indicators (242) may include the first main gear load signal, the second main gear load signal, the first brake temperature signal, the second brake temperature signal, the flight deck commanded (block 216) first motor torque (block 218), and second motor torque (block 220), the calculated first motor torque and speed (block 224), and the calculated second motor torque and speed (block 226). In other embodiments, other electric taxi system operating parameters may be included in the condition indicators (242) as would be known in the art. The HM controller 150 may generate maintenance advice as a function of the condition indicators (244) and the fault condition reasoner logic (block 240). In one example, the HM controller 150 may compare the first commanded torque (block 218) with the first motor torque (block 224) and generate electric taxi system maintenance signals as a function of the comparison. In another example, the HM controller 150 may compare the second commanded torque (block 220) with the second motor torque (block 226) and generate electric taxi system maintenance signals as a function of the comparison.

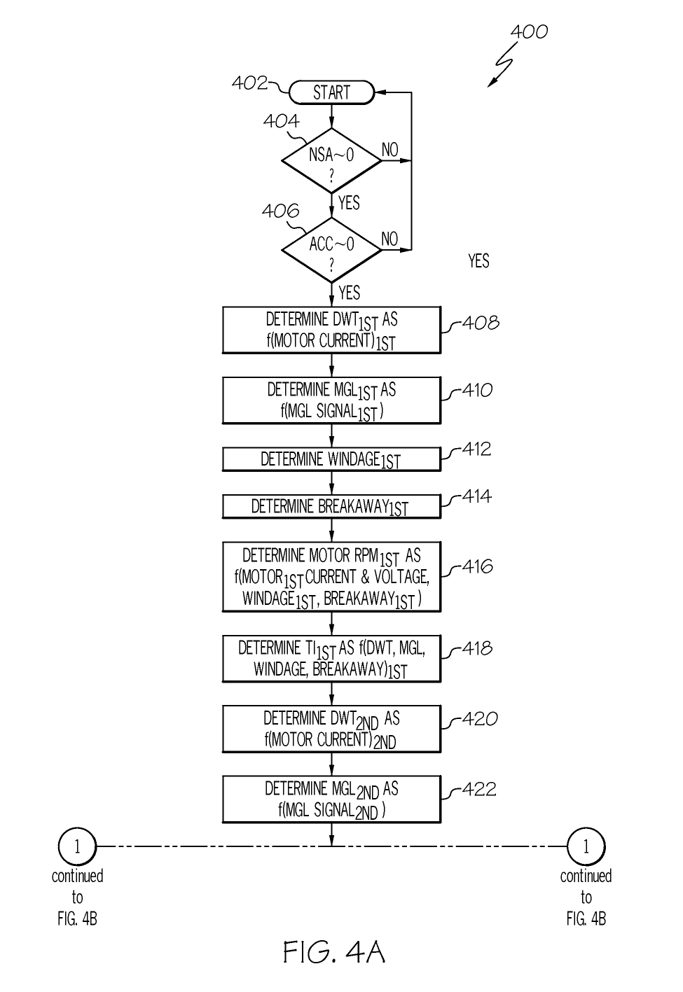

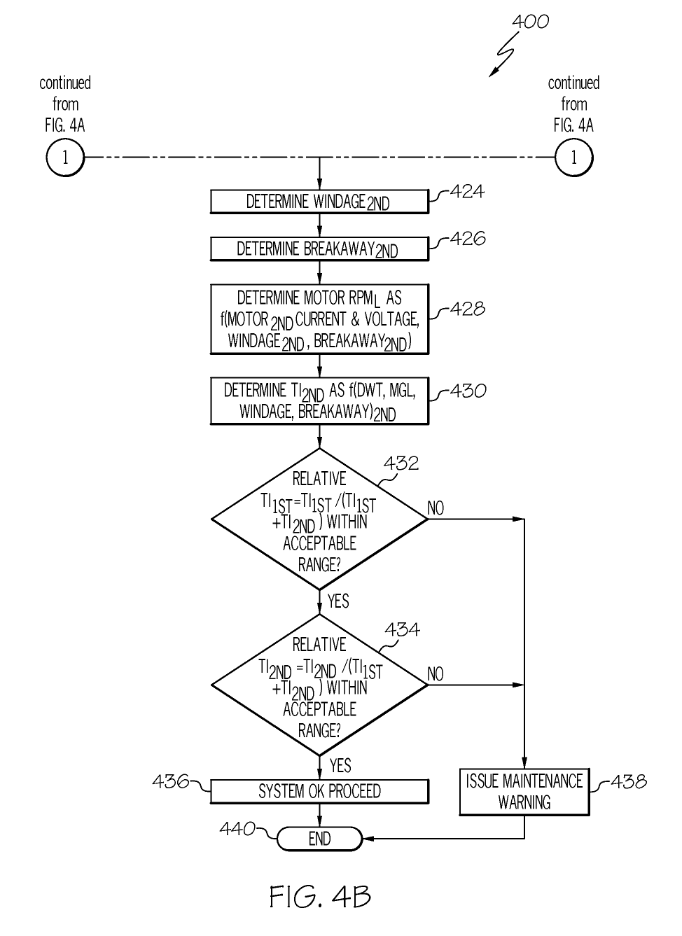

The fault condition reasoner logic may be in the form of tables, algorithms, models, state machines, or other methods of determining faults and providing maintenance advice as is known in the art. Non-limiting examples may be methods of determining if tires are properly inflated, methods of determining brake pad wear, methods of preventing skid, methods of controlling traction, methods of determining side loading, methods of determining weight and balance, and methods of determining wear or damage to the first motor 132 or the second motor 134 components. Exemplary methods which may be included in the fault reasoner logic are described in relation to FIGS. 4A, 4B, 5A, 5B, 6-7, 8A, 8B, 9A, and 9B, but additional methods may also be included.

Referring now to FIGS. 4A and 4B, an exemplary method 400 of checking tire 140 inflation for an aircraft electric taxi system is illustrated. The method 400 may be part of the reasoner fault logic included in the HM controller 150, and may determine if tire inflation is acceptable through a relative tire inflation calculated from the tire inflation of a first tire 140 and a second tire 140. The method starts (step 402) and the nose gear steering angle (NSA) may be determined. The NSA may be determined as described in relation to FIG. 2 in a variety of ways. If the NSA is within a predetermined range—approximating zero—the method 400 may continue. If the NSA is out of the predetermined range the method 400 goes back to start, and may include a time delay (not shown) before beginning again (step 404). Ensuring that the NSA is approximately zero ensures that both the first tire 140 and the second tire 140 are experiencing similar operating conditions. The acceleration (ACC) may be determined as a function of the first and second motor speeds. In other embodiments the acceleration may be determined in alternative ways such as through a speed sensor on a wheel (not shown), a GPS system, or any other method known in the art. If the ACC is within a predetermined acceptable range—approximately zero—the method 400 may continue. If the ACC is not in the predetermined acceptable range, the method 400 may begin again and may include a time delay (step 406).

The first drive wheel torque (DWT₁ₛₜ) may be determined as a function of the first motor current as is known in the art (step 408). The first main gear load (MGL₁ₛₜ) may be determined from the first main gear load signal (step 410). A first windage (windage₁ₛₜ) may be a force the first motor torque must overcome created on the aircraft 101 by friction from air, and may be a function of aircraft 101 characteristics and weight, and environmental conditions such as wind speed and ground condition. The windage₁ₛₜ may be calculated as is known in the art (step 412). A first breakaway (breakaway₁ₛₜ) may be the friction force the first motor torque must overcome before the first wheel may begin turning. The breakaway may be calculated as is known in the art (step 414). The first motor speed (RPM₁ₛₜ) may be calculated as a function of the first motor current, the first motor voltage, the first windage, and the first breakaway as is known in the art (step 416).

The first tire inflation (TI₁ₛₜ) may be calculated as a function of DWT₁ₛₜ, MGL₁ₛₜ, windage₁ₛₜ, and breakaway (step 418). The second tire inflation (TI_{2nd}) may be calculated similarly to the TI₁ₛₜ (steps 420-430). For example, the TI₁ₛₜ and TI_{2nd} may be expressed as follows:

TIX=f(DWT_{X},MGL_{X},RPM_{X}) Equation 1

where DWT is the drive wheel torque, MGL is the second main gear load, RPM is the second motor speed, and the subscript X designates first or second.

A relative TI₁ₛₜ and TI_{2nd} may be calculated as a function of TI₁ₛₜ and TI_{2nd}. For example, the relative TI₁ₛₜ and TI_{2nd} may be calculated per the equation below:

Relative TI_{X}=TI_{X}/(TI₁ₛₜ+TI_{2nd}) Equation 2

If both the relative TI₁ₛₜ and the relative TI_{2nd} are in an acceptable range (steps 432 and 434), the inflation of both tires 140 is acceptable (step 440). If either the relative TI₁ₛₜ and the relative TI_{2nd} are not in the acceptable range then the HM controller 150 may issue maintenance advice including a specific maintenance warning with information on which side tires 140 may not have acceptable tire inflation (step 438). The method 400 then ends (step 440).

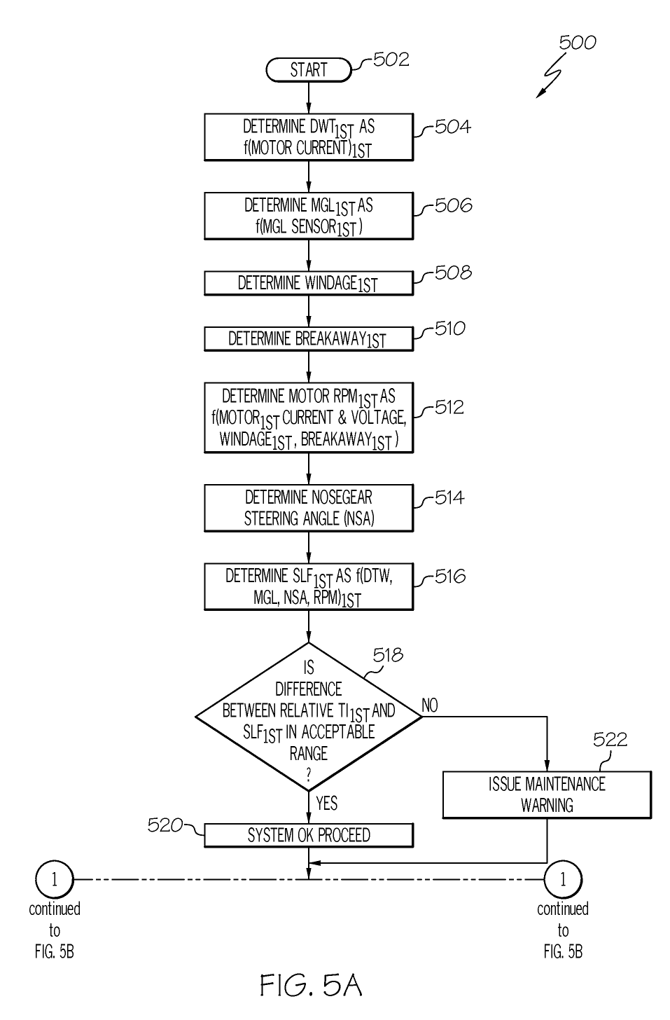

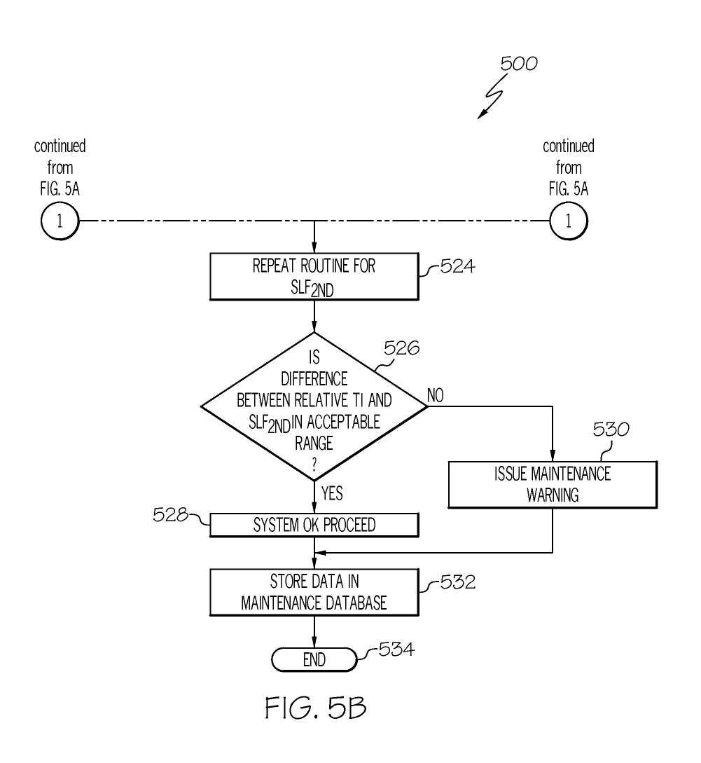

Referring now to FIGS. 5A and 5B, a method 500 to check side loading for an aircraft 101 electric taxi system is illustrated. The health management system 100 may perform periodic or event triggered maintenance checks during taxi operations to both diagnose problems before they must be immediately addressed and to collect and store information through which maintenance and service may be planned. Excessive side loading of an aircraft may cause increased tire 140 wear and tires 140 may have to be replaced sooner. A record of when a side load factor is outside an acceptable range may aid maintenance personnel in determining proper service periods. In extreme side loading of a tire 140, the tire 140 may deflate, overstress the strut on the landing gear assembly 136, 138, and/or come off the rim. Determining a critical side load immediately may allow corrective action before damage occurs.

The method starts (step 502) and the DWT₁ₛₜ, MGL₁ₛₜ, windage₁ₛₜ, breakaway₁ₛₜ, RPM₁ₛₜ, and NSA may be determined similarly to the method 400 to check tire inflation described above in relation to FIG. 4, or by any method known in the art (steps 504-514). The first side load factor (SLF₁ₛₜ) may be determined as a function of the DWT₁ₛₜ, MGL₁ₛₜ, RPM₁ₛₜ, and the sine of NSA (step 516). For example, the SLF₁ₛₜ may be expressed as follows:

SLF_{X}=f(DWT_{X},RPM_{X},MGL_{X},sin(NSA)) Equation 3

where SLFx is the side load factor, DWTx is the drive wheel torque, RPMx is the motor speed, MGLx is the main gear load, NSA is the nosegear steering anglem and the subscript x refers to which landing gear the side load factor is being calculated on (first or second).

The SLF₁ₛₜ may be compared with the relative TI₁ₛₜ which may be determined similarly to the method 400 described above in relation to FIG. 4 (step 518). If the difference between the SLF₁ₛₜ and the relative TI₁ₛₜ is determined to be in a predetermined acceptable range, the SLF₁ₛₜ may be considered to be acceptable (step 520). If the difference between the SLF₁ₛₜ and the relative TI₁ₛₜ is determined not to be in a predetermined acceptable range, the HM controller 500 may generate a maintenance warning in any of the embodiments previously in relation to FIGS. 2-3, 4A, and 4B, or in any way known in the art (step 522). If the difference between the SLF₁ₛₜ and the relative TI₁ₛₜ is determined to be greater than a predetermined critical value, the HM Controller 150 may generate emergency maintenance signals.

The second side load factor (SLF_{2nd}) may be determined in a similar manner as the SLF₁ₛₜ (step 524) and compared to the relative TI_{2nd} in a similar manner (step 526). If the difference between the SLF_{2nd} and the relative TI_{2nd} is determined to be in a predetermined acceptable range, the SLF_{2nd} may be considered to be acceptable (step 528). If the difference between the SLF_{2nd} and the relative TI_{2nd} is determined not to be in a predetermined acceptable range, the HM controller 500 may generate a maintenance warning in any of the embodiments previously in relation to FIGS. 2-3, 4A, and 4B, or in any way known in the art (step 530). If the difference between the SLF_{2nd} and the relative TI_{2nd} is determined to be greater than a predetermined critical value, the HM Controller 150 may generate emergency maintenance signals.

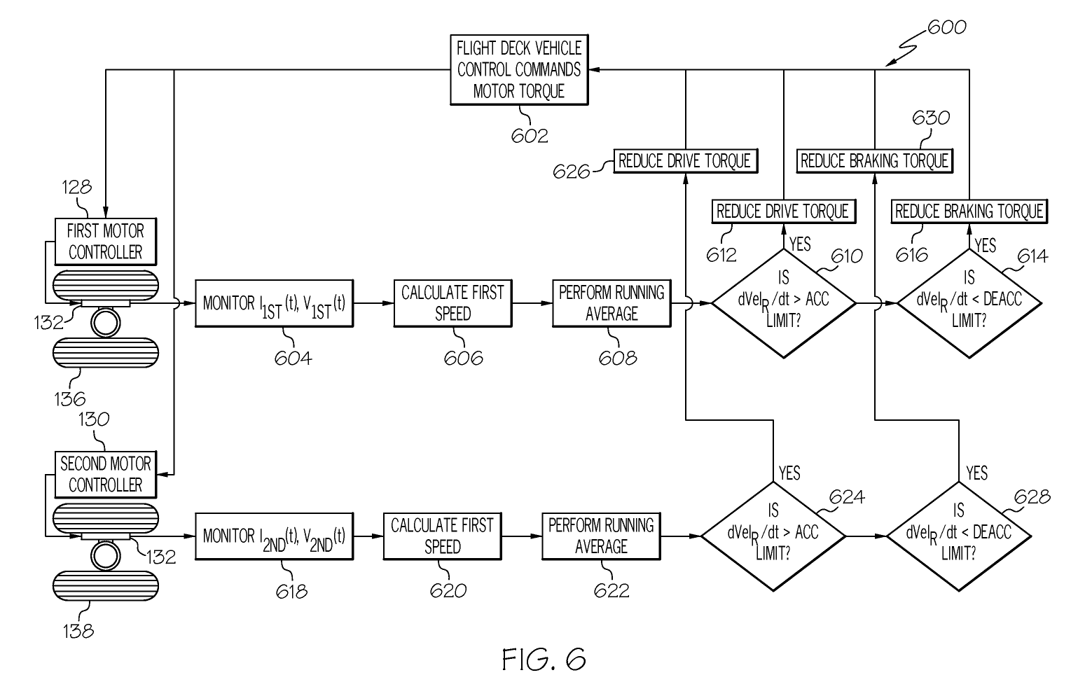

Referring now to FIG. 6, a traction control and skid control method 600 for an aircraft electric taxi system is illustrated. Components shown in FIG. 6 which are similar to those shown in FIG. 1 have similar element numbers, and will not be described again. When a wheel in the landing gear assembly 136, 138 breaks contact with its rolling surface and rapidly decelerates, the wheel may be skidding. When a wheel breaks contact with its' rolling surface and rapidly accelerates, the wheel may have lost traction control. Both the skid and loss of traction control conditions may be detected by the HM system 100 through monitoring the first and second motor current and voltage. The HM system 100 may issue warnings and/or send operating commands modifying pilot interface unit 112 torque commands when skid and loss of traction control conditions are detected. Skidding of, or loss of traction in one of the first or second wheel, may result in a difference in first motor speed and second motor speed which may trigger a maintenance flag as described in relation to FIG. 2. Method 600 may be included in the fault detection logic of the HM controller 150. Method 600 may also be implemented by HM controller 150 outside of the framework of the method described in relation to FIG. 2.

A pilot or other operator may enter vehicle control commands from the flight deck of the aircraft 101 through the pilot interface unit 112 which may be translated into first motor toque commands and second motor torque commands (block 602). The first and second motor current and voltage may be monitored by the first and second motor controllers 128, 130 respectively (block 604, 618). The first and second motor controllers 128, 130 may calculate the first motor speed as a function of the first motor current and voltage; and the second motor speed as a function of the second motor current and voltage, as described above in reference to FIGS. 2-3, 4A, 4B, and 5, or by any other method known in the art (block 606, 620), and generate first motor signals and second motors signals including the first motor speed and the second motor speed.

The HM controller 150 may perform a running average of the first motor speed and the second motor speed (block 608, 622) and determine the first motor acceleration (dVel₁ₛₜ/dt) and the second motor acceleration (dVel_{2ND}/dt).

In order to maintain traction control of the first wheel, the HM controller 150 may compare the dVel₁ₛₜ/dt with a traction control predetermined acceleration limit (ACCthreshold-trac) (block 610) and if dVel₁ₛₜ/dt is greater than the ACCthreshold-trac, generate a reduce drive torque signal (block 612). The reduce drive torque signal may trigger a flight deck warning, for example in the form of a visual or audio signal, or a modification of the first motor torque commands. A modification of the first motor torque commands may assist the first wheel in regaining or maintaining traction control. Similarly, in order to maintain traction control of the second wheel, the HM controller 150 may compare the dVel_{2nd}/dt with the ACCthreshold-trac (block 624) and if dVel_{2nd}/dt is greater than the ACCthreshold-trac, generate a reduce drive torque signal (block 626). The reduce drive torque signal may trigger a flight deck warning or a modification of the second motor torque commands. A modification of the second motor torque commands may assist the second wheel in regaining or maintaining traction control.

In order to prevent skidding of the first wheel, the HM controller 150 may compare the dVel₁ₛₜ/dt with an anti-skid predetermined acceleration limit (ACCthreshold-skid) (block 614) and if dVel₁ₛₜ/dt is less than the ACCthreshold-skid, generate a reduce braking torque signal (block 616). The reduce braking torque signal may trigger a flight deck warning, for example in the form of a visual or audio signal, or a modification of a first braking command. A modification of the first braking command may assist in preventing, limiting, or stopping skidding of the first wheel. Similarly, in order to prevent skidding of the second wheel, the HM controller 150 may compare the dVel_{2nd}/dt with the ACCthreshold-skid (block 628) and if dVel_{2nd}/dt is less than the predetermined ACCthreshold-skid, generate a reduced braking torque signal (block 630). The reduce braking torque signal may trigger a flight deck warning or a modification of a second braking command. A modification of the second braking command may assist in preventing, limiting, or stopping skidding of the second wheel.

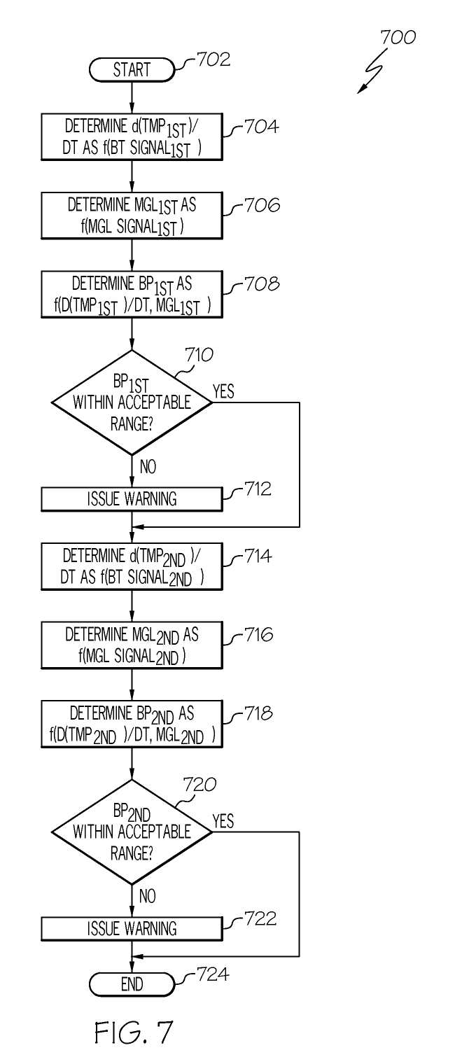

Referring now to FIG. 7, a method 700 to monitor brake wear for an aircraft electric taxi system is illustrated. Monitoring the wear of a brake pad on the first wheel or the second wheel may allow service personnel to better plan when to replace brake pads on a taxi system. Uneven wear of brake pads may cause differences in the first motor speed and the second motor speed; and/or differences in the first motor torque or the second motor torque which may trigger a maintenance flag as described in relation to FIG. 2. Method 700 may be included in the fault detection logic of the HM controller 150. Method 700 may also be implemented by HM controller 150 outside of the framework of the method described in relation to FIG. 2.

During mechanical braking upon landing of the aircraft 101, the aircraft 101 kinetic energy may be counteracted by reverse engine thrust and heating of the brake rotors, pads, and calipers. As the brake pads wear, their thermal capacity may be reduced and a heat path length to the calipers may be reduced, potentially resulting in a faster increase in the temperature of the calipers and a faster increase in the first brake temperature (BT) signal and/or the second BT signal. A trend showing that the rate at which the first BT signal and/or the second BT signal increases is increasing, may be related to brake pad thickness and wear.

The method 700 starts (step 702) and the rate of increase in the first brake caliper (d(BTₛₜ)/dt) may be determined as a function of the first BT signal (BT Signal₁ₛₜ) (step 704) by the HM controller 150. The MGL₁ₛₜ may be determined as a function of the first main gear load signal (step 706) by the HM controller 150. First brake pad wear (BP₁ₛₜ) may be determined as a function of the d(BT₁ₛₜ)/dt and the MGL₁ₛₜ (step 708) by the HM controller 150. For example, BP₁ₛₜ may be expressed as follows:

BP_{X}=f(d(BT_{X})/dt,MGL_{X}) Equation 4

where BP_{X} is brake pad wear, d(BT_{X})/dt is the rate of change of the BT signal, MGL_{X} is the load on the main gear of the landing assembly, and the subscript X indicates the side (first or second).

The HM controller 150 may compare the BP₁ₛₜ with one or more predetermined threshold values and as a result of the comparison determine if the BP₁ₛₜ is in an acceptable range (step 710). If the BP₁ₛₜ is not in an acceptable range the HM controller 150 may generate a maintenance warning (712). The maintenance warning may be stored, and/or displayed or in other ways communicated to the flight deck and/or other personnel.

The HM controller 150 may determine the second brake pad wear (BP_{2nd}) (steps 714-718), determine if BP_{2nd} is in an acceptable range (step 720), and if not generate a maintenance warning (step 722), in a similar way as BP₁ₛₜ. The method 700 may then end (step 724).

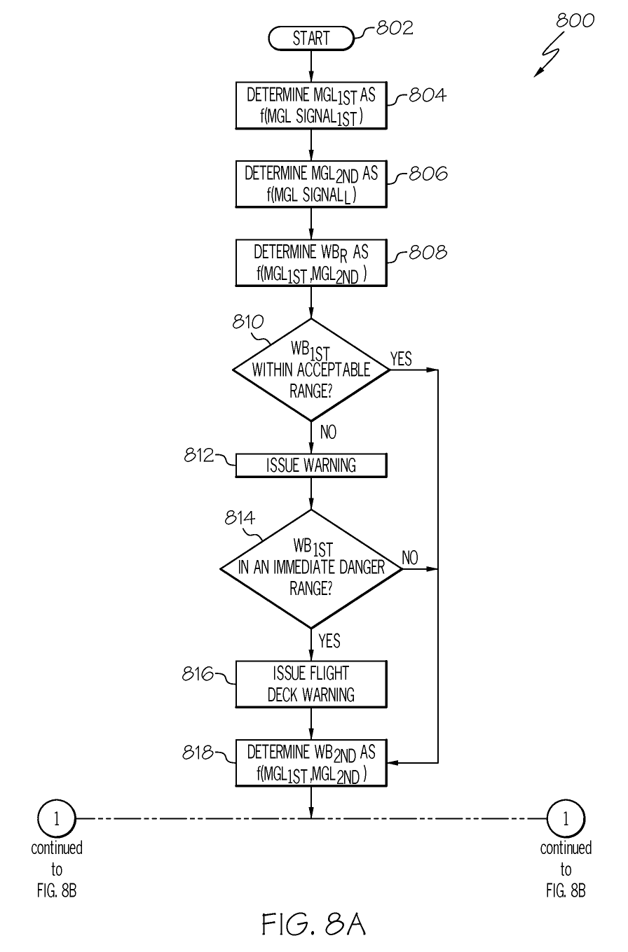

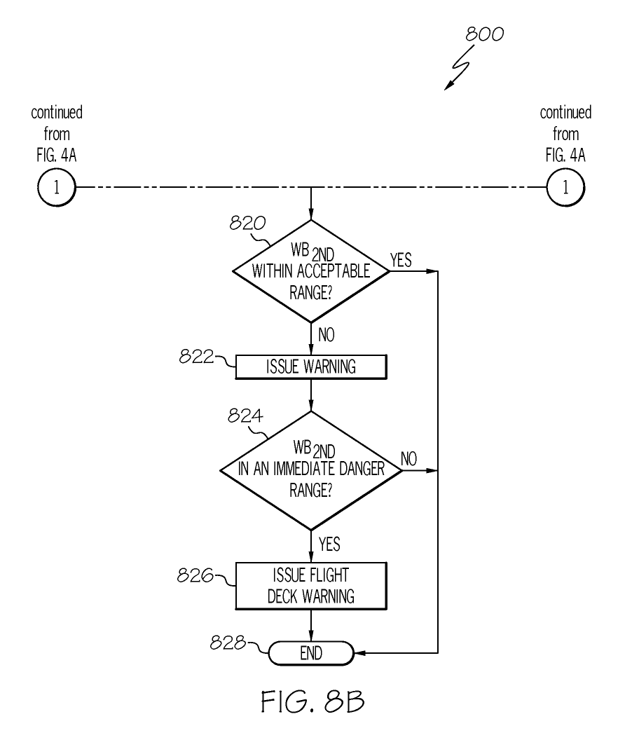

Referring now to FIGS. 8A and 8B, a method 800 to monitor the weight and balance of an aircraft 101 with an electric taxi system is illustrated. The HM system 100 may be able to monitor the weight and balance of the aircraft during taxi operations. The method 800 may start (step 802) and the HM controller 150 may determine the MGL₁ₛₜ and MGL_{2nd} as a function of the first MGL signal and the second MGL signal (steps 804, 806). The HM controller may determine a first weight balance (WB₁ₛₜ) as a function of the MGL₁ₛₜ and MGL_{2nd} (step 808). The WB₁ₛₜ may indicate if and how much the weight in aircraft 101 may be out of balance between the first and second side. If the weight in the aircraft 101 is out of balance, the tires 140 and other components of the landing gear assemblies 136, 138 may wear unevenly, and a side load on the tires 140 or components of the landing gear assemblies 136, 138 may be introduced, which may cause undesirable wear or damage. The WB₁ₛₜ may, for example, be determined by the following equation:

WBX=MGLX/(MGL₁ₛₜ+MGL_{2nd}) Equation 5

where WBX is weight and balance, MGLX is the load on the main gear of the landing assembly, and the subscript X indicates the side (first or second), subscript 1st indicates the first side, and subscript 2nd indicates the second side.

Ideally, the WB₁ₛₜ equals 0.5. The HM controller 150 may determine if the WB₁ₛₜ is in an acceptable range (step 810), and if the WB₁ₛₜ is not in an acceptable range, the HM controller 150 may generate a warning (step 812) which may be stored in the HM controller memory and/or be communicated through display or audio means to the pilot or other personnel. The HM controller 150 may determine if the WB₁ₛₜ is in a danger range (step 814), and if the WB₁ₛₜ is in a danger range, the HM controller 150 may generate a flight deck warning which may immediately inform personnel in the flight deck that a serious weight balance issue exists (step 816). Although determining WB₁ₛₜ may determine any weight balance problem, the HM controller 150 may repeat these steps for the second side of the aircraft 101 (steps 818-826) as a failsafe and then end (828).

Referring now to FIG. 9A, a health management method 900 for electric motors 132, 134 in an aircraft electric taxi system is illustrated. The method 900 may relate to condition based maintenance (CBM), an approach to identifying and performing maintenance only when there is evidence of need. CBM shifts equipment maintenance from unscheduled, reactive maintenance at the time of failure, or a schedule based maintenance approach, to a more proactive and predictive method that is driven by condition sensing. When condition sensing is coupled with analysis-based prediction of impending failures, more timely and effective repairs may be realized along with improved system availability, and may result in a reduction of maintenance or service costs. CBM may be accomplished by monitoring motor control signals, and motor thermal and electrical response and analyzing the current and voltage signatures under the given control conditions. The sensed data may be further analyzed to extract condition indicators (CIs) 982 (shown in FIG. 9B) from the motors 132, 134. The CIs may be derived from data streams using a variety of time and frequency domain methods including current and voltage signature analysis, residual estimation, signal segmentation, thresholding and spectral analysis techniques. Once determined the CIs may be further processed by diagnostic and progression operators and may be aggregated within a reasoner to provide diagnostic and prognostic maintenance guidance.

Components of the HM system 100 illustrated in FIG. 9A which have been previously described in relation to FIG. 1, and method steps described in relation to FIG. 2, are given the same element numbers and will not be described again.

The load determination module 158 in the HM controller may determine the load (block 902) on the first and second motors 132, 134. In addition to monitoring the first and second motor current and voltage (block 220, 222), the first and second motor controllers 128, 130 (or alternatively, the HM controller 150) may monitor the temperature of the first and second motors 132, 134 (block 906, 908). The temperatures of the motors 132, 134 may be monitored by thermocouples in the windings or frame, or in any way known in the art.

The HM controller 150 may calculate first motor CIs 982 as a function of the first motor load, the first motor current, the first motor voltage, the first motor speed, the first motor torque, the first motor commanded torque, and the first motor desired speed, and may utilize an electric current predictor model 930 (shown in FIG. 9B) contained in the e-taxi performance model 159. The HM controller 150 may calculate second motor CIs 982 as a function of the second motor load, the second motor current, the second motor voltage, the second motor speed, the second motor torque, the second motor commanded torque, and the second motor desired speed, and may utilize an electric current predictor model contained in the e-taxi performance model 159.

Referring now to FIG. 9B, an exemplary method of calculating 910, 912 and generating CIs 982 of electric motors 132, 134 in an aircraft 101 electric taxi system is illustrated. To assess the health of the motors 132, 134, the HM system 100 may generate several CIs 980 such as the peak, RMS, Total Harmonic Distortion, and Symmetrical Component of the first and second motor currents; motor temperature CIs 970, and CIs 978 calculated from the monitored and desired motor speeds and torques. Broadly speaking, there may be two types of motor faults—mechanical faults such as the misalignment, bearing failure, or broken bars; and electrical faults such as winding failures. The CIs 982 may detect both mechanical and electrical faults. The CIs 982 may capture motor symptoms that may occur when there is a fault. However, the same symptoms that CIs 982 may be designed to capture might be exhibited due to disturbances other than faults. The symptoms that may result from the disturbances may be the main cause of maintenance flags and warnings which may be false alarms and frequent false alarms may result in a HM system 100 which is less robust than desired.

In the case of motors 132, 134, supply voltage variation may produce motor current characteristics similar to symptoms of faults that the CIs 982 may be designed to capture. Residual motor currents 942 may be the difference between the monitored motor currents and a model predicted current, and may decouple the effect on motor current characteristics due to supply voltage variations from the effect due to actual faults. The e-taxi performance model 156 may include the electric current predictor model 930. The current predictor model 930 may include one or more models 938. The models 938 may include any type of current prediction model known in the art, including, for example, a first principle model and/or an empirical model. The models 938 may include models which predict motor current more accurately when the motor loads are within a predetermined range. Multiple models 938 may be included in the electric current predictor model 930, and may each predict motor current more accurately within different predetermined load ranges, but together may cover a broad load range.

Motor load variation may also produce current characteristics similar to symptoms of faults that the CIs 982 may be designed to capture. Motor load variation may produce non-stationary voltage and current signals. Signal processing the steady-state and transient current signals separately may decouple the effect on motor current characteristics due to motor load variations from the effect due to actual faults. Signal segmentation technique may be used to separate the motor current and residual current signals into steady-state and the transient components. CIs 980 may be computed using different methods for steady-state and the transient monitored and residual current components. CIs 980 from steady-state signals may be computed using fast Fourier transform methods (FFT), whereas CIs 980 from transient signals may be computed based on multi-resolution analysis, such as wavelet or time-frequency analysis.

The flow chart of FIG. 9B illustrates an exemplary method for calculating CIs 982 for the first and second motors. However, in the description below signals are described generically rather than as a first motor or second motor signal. It should be understood that the input signals and output CIs 982 may be associated with either the first or the second motor 132, 134.

The current predictor model 930 may generate a model predicted current signal 940 as a function of motor load 926, speed 932, and voltage 934 signals. The current prediction model 930 may use any of multiple current prediction models 938 to generate the model predicted current signal 940 based on the load signal 926. The current predictor model 930 may, for example, include a table matching load signals 926 with appropriate models 938. The model predicted current signal 940 may be compared with the monitored current signal 936 and a residual current signal 942 generated.

A signal segmentation module 944 may separate the residual current signal 942, and the monitored current signal 936 into monitored and residual stationary current signals 946, and monitored and residual non-stationary current signals 948; as a function of the voltage signal 934. A harmonics separation module 950 may separate the monitored stationary current signal 946, the monitored non-stationary current signal 948, the residual stationary current signal 946, and the residual non-stationary current signal 948, into fundamental 956, 958 and harmonic 960, 962 component signals. A CI computation module 964 may compute Peak, RMS, Total Harmonic Distortion, and/or Symmetrical Component CIs 980 from the monitored stationary fundamental current signal 958, the monitored stationary harmonic current signal 962, the monitored non-stationary fundamental current signal 958, the monitored non-stationary current signal 962, the residual stationary fundamental current signal 956, the residual stationary harmonic current signal 960, the residual non-stationary fundamental current signal 956, and the residual non-stationary harmonics current signal 960.

A temperature monitoring module 968 may generate a CI 970 based on motor temperature signals 966. A control loop monitoring module may produce a CI 978 based upon a comparison of the desired motor torque and speed 972, and the actual motor torque and speed 974.

Referring now back to FIG. 9A, the first and second CIs 982 may be compared (block 914) if the HM controller 150 determines that equal torque and equal speed may be expected from the first and second motors 132, 134 (block 218).

A progression operator may analyze the CIs 982 and difference between the first and second CIs 982s to calculate trends in the periodic CI 982 and difference signals (block 916). Trend analysis of signals is known in the art. A diagnostic operator may analyze the CIs 982 and difference between the first and second CIs 982 to determine real time faults (block 918). For example, the diagnostic operator may compare CIs 982 or functions of the CIs 982 with predetermined limits and ranges. Diagnostic analysis of signals is known in the art. If real time faults are determined to exist, the HM controller 150 may generate maintenance flags and warnings (block 924).

CI 982 trend data associated with faults of the particular motors 132, 134 on the aircraft 101 may be stored in the HM controller 150. The HM controller 150 may determine relevant stored trend data (block 920) and compare this trend data with CIs 982 trend data from the progressive operator (block 922). Based on the comparison, the HM controller 150 may store or generate maintenance flags, information and/or messages (block 924).

It should be understood, of course, that the foregoing relates to exemplary embodiments of the invention and that modifications may be made without departing from the spirit and scope of the invention as set forth in the following claims.

We claim:

1. An aircraft electric taxi health management system, comprising:
a pilot interface unit configured to accept taxi drive commands, and generate a first torque command and a second torque command as a function of the taxi drive commands;
a first electric motor drivingly connected to at least one wheel on a first landing gear assembly, and including a first motor current and a first motor voltage;
a second electric motor drivingly connected to at least one wheel on a second landing gear assembly, and including a second motor current and a second motor voltage;
a first motor controller configured to electrically drive the first electric motor as a function of the first torque command, monitor the first motor current and the first motor voltage of the first electric motor, and generate a first motor torque signal as a function of the first motor current and the first motor voltage;
a second motor controller configured to electrically drive the second electric motor as a function of the second torque command, monitor the second motor current and the second motor voltage of the second electric motor, and generate second motor torque signal as a function of the second motor current and the second motor voltage; and
a health management controller configured to compare the first torque command and the first motor torque signal, and the second torque command and the second motor torque signal, and generate electric taxi system maintenance signals as a function of the comparison.

2. The health management system of claim 1,
further including a heading indicator system configured to generate a heading signal indicative of a heading of the aircraft; and
wherein;
the first motor controller is configured to generate a first motor speed signal as a function of the first motor current and the first motor voltage;
the second motor controller is configured to generate second motor speed signal as a function of the second motor current and the second motor voltage; and
the health management controller is configured to;
a) determine a torque difference running average of the difference between the first motor torque and the second motor torque, and compare the torque difference running average to a predetermined torque difference limit;
b) determine a speed difference running average of the difference between the first motor speed and the second motor speed, and compare the speed difference running average to a predetermined speed difference limit; and
c) generate a maintenance flag when the torque difference running average exceeds the torque difference limit, and/or the speed difference running average exceeds the speed difference limit; and the heading signal indicates the aircraft is traveling in a straight path.

3. The health management system of claim 2, wherein the health management controller is configured to generate maintenance advice signals when a maintenance flag is generated, the maintenance advice signals generated as a function of condition indicator signals and predetermined fault condition logic.

4. The health management system of claim 3, wherein;
the condition indicators include a first load signal indicative of the load on the first landing gear assembly, and generated by a first main gear load sensor; a second load signal indicative of the load on the second landing gear assembly, and generated by a second main gear load sensor; first motor signals including a first drive wheel torque and a first motor speed; and second motor signals including a second drive wheel torque and a second motor speed; and
the health management controller is configured to;
a) determine a relative first wheel tire inflation as a function of the first drive wheel torque, the first main gear load signal, a first windage, a first breakaway, the second drive wheel torque, the second main gear load signal, a second windage, and a second breakaway;
b) determine a relative second wheel tire inflation as a function of the second drive wheel torque, the second main gear load signal, the second windage, and the second breakaway, the first drive wheel torque, the first main gear load signal, the first windage, and the first breakaway; and
c) generate a tire inflation maintenance warning if the relative first wheel tire inflation is outside of a predetermined acceptable range; or if the relative second wheel tire inflation is outside of a predetermined acceptable range.

5. The health management system of claim 3, wherein;
the condition indicators include a first brake temperature signal indicative of the temperature of a component of a brake assembly of the first landing gear assembly, and generated by a first brake temperature sensor; a second brake temperature signal indicative of the temperature of a component of a brake assembly of the second landing gear assembly, and generated by a second brake temperature sensor; a first load signal indicative of the load on the first landing gear assembly, and generated by a first main gear load sensor; and a second load signal indicative of the load on the second landing gear assembly, and generated by a second main gear load sensor; and
the health management controller is configured to;
a) determine a first brake temperature derivative as a function of the first brake temperature signal over a predetermined time period;
b) determine a first brake pad wear as a function of the first brake temperature derivative and the first load signal;
c) determine a second brake temperature derivative as a function of the second brake temperature signal over the predetermined time period;
d) determine a second brake pad wear as a function of the second brake temperature derivative and the second load signal; and
e) generate a brake pad maintenance warning if the first brake pad wear is greater than a predetermined threshold; or if the second brake pad wear is greater than the predetermined threshold.

6. The health management system of claim 1, further including;
a first main gear load sensor configured to generate a first load signal indicative of the load on the first landing gear assembly;
a second main gear load sensor configured to generate a second load signal indicative of the load on the second landing gear assembly; and
a heading indicator system configured to generate a steering angle signal indicative of a nosegear angle; and
wherein;
the first motor signals include a first drive wheel torque and a first motor speed;
the second motor signals include a second drive wheel torque and a second motor speed; and
the health management controller is configured to;
a) determine a relative first wheel tire inflation as a function of the first drive wheel torque, the first main gear load signal, a first windage, a first breakaway, the second drive wheel torque, the second main gear load signal, a second windage, and a second breakaway;
b) determine a relative second wheel tire inflation as a function of the second drive wheel torque, the second main gear load signal, the second windage, and the second breakaway, the first drive wheel torque, the first main gear load signal, the first windage, and the first breakaway;
c) determine a first side load factor as a function of the first drive wheel torque, the first load signal, the first windage, the first breakaway, and the steering angle signal;
d) determine a second side load factor as a function of the second drive wheel torque, the second load signal, the second windage, the second breakaway, and the steering angle signal; and
e) generate a side load maintenance warning if the difference between the relative first wheel inflation and the first side load factor is outside a predetermined acceptable range, and/or the difference between the relative second wheel inflation and the second side load factor is outside a predetermined acceptable range.

7. The health management system of claim 1, wherein;
the first motor signals include a first motor speed and a first motor acceleration;
the second motor signals include a second motor speed and a second motor acceleration; and
the health management controller is configured to;
a) generate a reduce first drive torque signal when the first acceleration is greater than a predetermined first acceleration limit;
b) generate a reduce first braking torque signal when the first acceleration is less than a predetermined first deceleration limit;
c) generate a reduce second drive torque signal when the second acceleration is greater than a predetermined second acceleration limit; and
d) generate a reduce second braking torque signal when the second acceleration is less than a predetermined second deceleration limit.

8. The health management system of claim 1, further including;
a first main gear load sensor configured to generate a first load signal indicative of the load on the first landing gear assembly;
a second main gear load sensor configured to generate a second load signal indicative of the load on the second landing gear assembly; and
wherein the health management controller is configured to;
a) determine a relative first weight balance and a relative second weight balance as a function of the first load signal and the second load signal;
b) generate a weight balance maintenance warning if the relative first weight balance and/or the relative second weight balance are outside a predetermined acceptable range; and
c) generate a weight balance flight deck warning signal if the relative first weight balance and/or the relative second weight balance are inside a predetermined danger range.

9. The health management system of claim 1, further including;
a first motor temperature sensor configured to generate a first motor temperature signal indicative of the temperature of the first motor;
a second motor temperature sensor configured to generate a second motor temperature signal indicative of the temperature of the first motor; and
a heading indicator system configured to generate a heading signal indicative of a heading of the aircraft; and
wherein the health management controller includes a load determination module configured to generate an estimated first motor load, and an estimated second motor load; and is configured to;
a) determine first motor condition indicators as a function of the first torque command, the first motor signals, the estimated first motor load, and the first motor temperature signal;
b) determine second motor condition indicators corresponding to the first motor condition indicators as a function of the second torque command, the second motor signals, the estimated second motor load, and the second motor temperature signal;
c) perform a running comparison of at least one of the first motor condition indicators with an at least one corresponding second motor condition indicators and determine periodic condition indicator differences; when the heading signal indicates the aircraft is traveling in a straight path;
d) generate a diagnostic maintenance message when one of the periodic condition indicator differences is outside an acceptable range;
d) determine a trend in the periodic condition indicator differences, compare the trend with a corresponding expected trend, and determine a trend difference; and
e) generate a prognostic maintenance message when the trend difference is outside a predetermined acceptable range.

10. The health management system of claim 9, wherein;
the health management controller includes an e-taxi performance module including multiple motor current prediction models configured to generate a first predicted motor current as a function of the first motor signals and a second predicted motor current as a function of the second motor signals; and is configured to;
select one of the multiple current prediction models based at least in part on the estimated first motor load, and determine at least one of the first motor condition indicators as a function of a first motor model predicted current generated by the selected current prediction model; and
select one of the multiple current prediction models based at least in part on the estimated second motor load, and determine at least one of the second motor condition indicators as a function of a second motor model predicted current generated by the selected current prediction model.

11. An aircraft electric taxi health management method, comprising:
accepting taxi drive commands through a pilot interface unit;
generating a first torque command and a second torque command as a function of the taxi drive commands;
driving a first electric motor with a first motor controller based on the first torque command;
driving a second electric motor with a second motor controller based on the second torque command;
monitoring a first motor current and a first electric motor voltage of the first electric motor, and generating first motor signals as a function of the first motor current and the first motor voltage;
monitoring a second motor current and a second electric motor voltage of the second electric motor, and generating second motor signals as a function of the second motor current and the second motor voltage; and
comparing the first motor signals to the second motor signals; and
generating electric taxi system maintenance signals based on the comparison.

12. The health management method of claim 11, wherein the first motor signals include a first motor torque and a first motor speed; and the second motor signals include a second motor torque and a second motor speed; and further including;
generating a heading signal indicative of a heading of the aircraft;
determining a torque difference running average of the difference between the first motor torque and the second motor torque, and comparing the torque difference running average to a predetermined torque difference limit;
determining a speed difference running average of the difference between the first motor speed and the second motor speed, and comparing the speed difference running average to a predetermined speed difference limit; and
generating a maintenance flag when the torque difference running average exceeds the torque difference limit, and/or the speed difference running average exceeds the speed difference limit; and the heading signal indicates the aircraft is traveling in a straight path.

13. The health management method of claim 12, further comprising generating maintenance advice signals as a function of condition indicator signals and predetermined fault condition logic when a maintenance flag is generated.

14. The health management method of claim 11, further comprising;
generating a first motor temperature signal indicative of the temperature of the first motor;
generating a second motor temperature signal indicative of the temperature of the first motor; and
generating a heading signal indicative of a heading of the aircraft;
determining an estimated first motor load;
determining an estimated second motor load;
determining first motor condition indicators as a function of the first torque command, the first motor signals, the estimated first motor load, and the first motor temperature signal;
determining second motor condition indicators corresponding to the first motor condition indicators as a function of the second torque command, the second motor signals, the estimated second motor load, and the second motor temperature signal;
performing a running comparison of at least one of the first motor condition indicators with a corresponding at least one of the corresponding second motor condition indicators and determine periodic condition indicator differences; when the heading signal indicates the aircraft is traveling in a straight path;
generating a diagnostic maintenance message when one of the periodic condition indicator differences is outside an acceptable range;
determining a trend in the periodic condition indicator differences;
comparing the trend with a corresponding expected trend;
determining a trend difference; and
generating a prognostic maintenance message when the trend difference is outside a predetermined acceptable range.

15. The health management method of claim 11, further comprising;
generating a heading signal indicative of a heading of the aircraft;
determining an estimated first motor load;
determining an estimated second motor load;
selecting one of multiple current prediction models from an e-taxi performance module as a function of the estimated first motor load, and determining a first predicted motor current with the selected current prediction model;
selecting one of multiple current prediction models from the e-taxi performance module as a function of the estimated second motor load, and determining a second predicted motor current with the selected current prediction model;
determining first motor condition indicators as a function of the first motor signals, and the first predicted motor current;
determining second motor condition indicators corresponding to the first motor condition indicators as a function of the second motor signals, and the second predicted motor current;
performing a running comparison of at least one of the first motor condition indicators with a corresponding at least one of the corresponding second motor condition indicators and determine periodic condition indicator differences; when the heading signal indicates the aircraft is traveling in a straight path;
generating a diagnostic maintenance message when one of the periodic condition indicator differences is outside an acceptable range;
determining a trend in the periodic condition indicator differences;
comparing the trend with a corresponding expected trend;
determining a trend difference; and
generating a prognostic maintenance message when the trend difference is outside a predetermined acceptable range.

16. The health management method of claim 15, further comprising;
determining a residual first motor current as a function of the first motor current and the estimated first motor current;
determining a residual second motor current as a function of the second motor current and the estimated second motor current;
determining at least one of the first motor condition indicators as a function of the residual first motor current; and
determining at least one of the second motor condition indicators as a function of the residual second motor current.

17. The health management method of claim 16, further comprising;
determining a first stationary motor current and a first non-stationary motor current as a function of the first motor current;
determining a residual first stationary current and a residual first non-stationary motor current as a function of the residual first motor current;
determining a second stationary motor current and a second non-stationary motor current as a function of the second motor current
determining a residual second stationary current and a residual second non-stationary motor current as a function of the residual second motor current;
determining at least one of the first motor condition indicators as a function of the first stationary motor current;
determining at least one of the first motor condition indicators as a function of the first non-stationary motor current;
determining at least one of the first motor condition indicators as a function of the residual first stationary motor current;
determining at least one of the first motor condition indicators as a function of the residual first non-stationary motor current;
determining at least one of the second motor condition indicators as a function of the second stationary motor current;
determining at least one of the second motor condition indicators as a function of the second non-stationary motor current;
determining at least one of the second motor condition indicators as a function of the residual second stationary motor current; and
determining at least one of the second motor condition indicators as a function of the residual second non-stationary motor current.

18. The health management method of claim 17, further comprising;
separating at least one of the first stationary motor current, the first non-stationary motor current, the residual first stationary motor current, the residual first non-stationary motor current, the second stationary motor current, the second non-stationary motor current, the residual second stationary motor current, and the residual second non-stationary motor current into a harmonic current component and a fundamental current component; and wherein at least one of the first condition indicators is a function of the harmonic component and at least one of the first condition indicators is a function of the fundamental component.

19. The health management method of claim 17, further comprising;
separating at least one of the first stationary motor current, the residual first stationary motor current, the second stationary motor current, and the residual second stationary motor current into a harmonic current component and a fundamental current component using fast fourier transform; and wherein at least one of the first condition indicators is a function of the harmonic component and at least one of the first condition indicators is a function of the fundamental component; and
separating at least one of the first non-stationary motor current, the residual first non-stationary motor current, the second non-stationary motor current, and the residual second non-stationary motor current into a harmonic current component and a fundamental current component using multi-resolution analysis; and wherein at least one of the first condition indicators is a function of the harmonic component and at least one of the first condition indicators is a function of the fundamental component.

20. An aircraft with an electric taxi system, comprising:
a pilot interface unit configured to accept taxi drive commands, and generate a first torque command and a second torque command as a function of the taxi drive commands;
a first landing gear assembly including a first electric motor drivingly connected to at least one wheel, the first electric motor including a first motor current and a first motor voltage;
a second landing gear assembly including a second electric motor drivingly connected to at least one wheel, the second electric motor including a second motor current and a second motor voltage;
an auxiliary power unit selectively electrically connected to a first electric motor controller and a second electric motor controller;
the first motor controller configured to electrically drive the first electric motor as a function of the first torque command, monitor a first motor current and a first motor voltage of the first electric motor, and generate first motor signals as a function of the first motor current and the first motor voltage;
the second motor controller configured to electrically drive the second electric motor as a function of the second torque command, monitor a second motor current and a second motor voltage of the second electric motor, and generate second motor signals as a function of the second motor current and the second motor voltage; and
a health management controller configured to compare the first motor signals to the second motor signals; and generate electric taxi system maintenance signals based on the comparison.
